(19) United States
(12) Patent Application Publication
(10) Pub. No.: US 2017/0190625 A1
(43) Pub. Date: Jul. 6, 2017

(54) FIRE-RESISTANT CERAMIC PRODUCT

(71) Applicant: Refractory Intellectual Property GmbH & Co. KG, Wien (AT)

(72) Inventors: Roland Nilica, Feistritz (AT); Alexander Platzer, Leoben (AT); Christoph Piribauer, Leoben (AT)

(21) Appl. No.: 15/313,082

(22) PCT Filed: Apr. 21, 2015
(86) PCT No.: PCT/EP2015/058603

§ 371 Date: Nov. 21, 2016

(30) Foreign Application Priority Data
Jun. 26, 2014 (EP) 14174575.2

(51) Int. Cl. C04B 35/053; C04B 35/64; C04B 35/63; C04B 35/628

(52) U.S. Cl. CPC C04B 35/053; C04B 35/62805; C04B 35/64; C04B 35/63; C04B 2235/3206; C04B 2235/3217; C04B 2235/3284; C04B 2235/5427; C04B 2235/656; C04B 2235/85; C04B 2235/78; C04B 2235/9607

(57) ABSTRACT

The invention relates to a fire-resistant ceramic product.

The invention relates to a refractory ceramic product.

For the purposes of the invention, the term “refractory ceramic product” refers, in particular, to ceramic products having a use temperature of above 600° C. and preferably to refractory materials in accordance with DIN 51060, i.e. materials having a pyrometric cone equivalent of >SK 17. The determination of the pyrometric cone equivalent can be carried out, in particular, in accordance with DIN EN 993-12.

Like most ceramic products, refractory ceramic products usually have a high brittleness. When mechanical stress is applied to the product, in particular when tensile forces also act on the product, cracks can be formed in the product and these can ultimately lead to fracture of the product.

A reduction in the brittleness of the refractory ceramic product enables its fracture toughness and thus its ability to withstand brittle destruction to be increased.

To reduce the brittleness of a refractory ceramic product, it is known that agents known as elasticizers or flexibilizers can be incorporated into the product in order to reduce the brittleness of the product and increase its fracture toughness. Elasticizers are generally particulate, refractory mineral raw materials which are based, for example, on refractory base materials such as magnesia (MgO), alumina (Al₂O₃), magnesia spinel (MgO.Al₂O₃) or forsterite (2 MgO.SiO₄). The mode of action of these elasticizers is based on them having a coefficient of thermal expansion which is different from that of the main component of the ceramic product, so that during ceramic firing of the product and subsequent cooling, stresses arise between the elasticizer and the main component. As a result, microcracks are formed in the ceramic product. In the case of mechanical attack on the product, these microcracks compensate part of the fracture energy, thus being able to reduce the risk of brittle fracture of the product.

The use of such elasticizers in refractory ceramic products has in principle been found to be useful for reducing the brittleness thereof. However, in some cases, desired materials combinations of ceramic main component and flexibilizer cannot be realized, for example because undesirable reactions between main component and elasticizer occur during ceramic firing of such a product, and these reactions stand in the way of use of the elasticizer. Thus, for example, the use of alumina (Al₂O₃) as flexibilizer in a refractory ceramic product based on magnesia (MgO) is desirable since alumina would, owing to its different coefficient of thermal expansion compared to magnesia, be suitable in principle as elasticizer for refractory ceramic products based on magnesia. However, when a ceramic product based on magnesia containing a flexibilizer in the form of alumina is fired, magnesia spinel (MgO.Al₂O₃) can be formed from the components magnesia and alumina. However, magnesia spinel has a lower density than alumina, so that the formation of magnesia spinel is associated with an increase in volume. This can result in buildup of mechanical stresses in the ceramic product, and these can lead to damage to or even fracture of the product.

It is an object of the invention to provide a refractory ceramic product whose fracture toughness has been increased by an elasticizer, with the range of elasticizers which can be used for the product being widened compared to the prior art.

To achieve this object, the invention provides a refractory ceramic product whose microstructure has the following features:

a matrix composed of at least one first material;
grains of at least one second material are embedded in the matrix;
the grains of the second material have a coating composed of at least one third material on at least part of their surface;
the first and second material have a different coefficient of thermal expansion;
the third material is stable during use of the product.

The refractory ceramic product of the invention proceeds firstly from the products known from the prior art which comprise an elasticizer to increase their fracture toughness. In this respect, the microstructure of the refractory ceramic product of the invention firstly comprises a first material which can form the at least one main component of the ceramic product, preferably forms the largest proportion by mass of the product and gives the product its main properties. This at least one first material or this at least one first main component forms a matrix in the product in which the grains of at least one second material are embedded. This second material forms an elasticizer for the product as a result of the second material having a different coefficient of thermal expansion than the at least one first material and produces, as is known from the prior art, microcracks in the refractory ceramic product of the invention during ceramic firing of the product.

An important novel feature of the refractory ceramic product of the invention compared to those products having an elasticizer according to the prior art is that the grains formed by the second material, i.e. the elasticizer, have a coating composed of at least one material which is stable during use of the product on their surface. This coating, which will for the purposes of the present invention be referred to as third material thus serves, owing to its stability during use of the product, as diffusion barrier between the first material and the second material or between the main component and the elasticizer, so that a reaction between the first material and the second material is prevented or at least largely suppressed when the product is subjected to thermal stress.

This diffusion barrier formed by the third material between the first material and the second material makes it possible for the spectrum of the elasticizers which can be used for the product to be wider than in the prior art, since materials which would undergo an undesirable reaction with the main component during use of the product if the elasticizer were not to have the coating according to the invention can also be used as elasticizer, i.e. the second material for the purposes of the invention.

The product of the invention can have one or more first materials, i.e. one or more main components. Likewise, the product of the invention can have one or more second materials, i.e. one or more elasticizers. Furthermore, the product of the invention can have one or more third materials, i.e. diffusion barriers, on the surface of the elasticizer. When the at least one first, second and third material are in the present text referred to for language reasons only in the singular as first, second or third material, the corresponding statements apply in the same way if a plurality of first, second or third materials are present in the product.

The following figures in % by mass relate, unless indicated otherwise in the particular case, to the proportion by mass of the respective component based on the total mass of the product of the invention.

The product of the invention can in principle be any type of refractory product, for example a shaped refractory product (i.e. a refractory brick), an unshaped refractory product (for example a mass) or a functional product. The product of the invention is preferably a shaped refractory product.

Furthermore, the product of the invention is preferably a sintered product, i.e. a refractory product having a ceramic bond.

The first material can be present in the form of grains in the product. Here, the grains of the first material can be present in the form of grains which are sintered together, so that the matrix formed by the first material in the microstructure of the product of the invention forms a matrix made up of grains of the first material which have been sintered together.

The grains composed of the first material can form a contiguous matrix over the total volume of the product.

The second material is present in the form of grains in the microstructure of the product of the invention, with these grains being embedded in the matrix formed by the first material. Here, the grains composed of the second material can be embedded as isolated islands of individual or mutually sintered grains in the matrix formed by the first material. These isolated islands of individual or mutually sintered grains composed of the second material can be at least partially sintered to the matrix via the coating formed by the third material.

The grains composed of the second material have a coating composed of at least one third material on at least part of the surface, preferably over their entire surface. The grains of the second material particularly preferably have a coating composed of the at least one third material on an average of at least 80% of their surface, particularly preferably on an average of at least 85, 90 or even 95% of their surface. This ensures that the third material acts to a large extent as diffusion barrier between the first material and second material, so that the first material and second material largely do not react with one another and thus do not produce any undesirable reaction products in the product during use of the product.

For the purposes of the invention, “use” of the product is the intended use of the product under the conditions prevailing there, i.e. the conditions to which the product is subjected during the intended use, in particular the prevailing temperature and atmosphere. Since refractory ceramic products are routinely subjected to high temperatures, in particular in the temperature range from about 600 to about 2000° C., during use, the third material is, for example, also stable when the product is subjected to a temperature of, for example, more than 600° C., 800° C., 1000° C., 1200° C., 1300° C., 1400° C. or 1500° C.

The third material being “stable” during use of the product, thus particularly, for example, when the product is subjected to the above temperatures, expresses, according to the invention, the fact that the third material represents a diffusion barrier for the first material and second material during use of the product. The third material is thus present, during use of the product, in such a form that it completely suppresses or largely prevents a reaction of the first material with the second material, so that no or no appreciable undesirable reaction between the first material and second material occurs during use of the product.

Furthermore, the third material has such a nature that it does not decompose and does not form a melt during use of the product. In this respect, it can be provided according to the invention that, in particular, the invariant point in the materials systems composed of the first material and third material and also of the second material and third material is in each case above the use temperature of the product.

The first, second and third material are the phases, i.e. the mineral phases, which form the microstructure of the product.

The at least one first material can in principle be any one or more mineral phases which are known from the prior art as main mineral phases or main components for refractory ceramic products. In particular, the first material can be based on one or more of the following oxides or compounds: MgO, Al₂O₃, Fe₂O₃, SiO₂, CaO, Cr₂O₃, ZrO₂, Mn₂O₃, TiO₂ or one or more compounds of these oxides, for example magnesia spinel (MgO.Al₂O₃), hercynite (MgO.Fe₂O₃), galaxite (MgO.Mn₂O₃) or forsterite (2 MgO.SiO₂).

The first material is preferably based on at least one of the following oxides: MgO, Al₂O₃ or CaO. The first material can particularly preferably be based on MgO.

A material being “based” on an oxide or compound mentioned here, expresses, according to the invention, the fact that the material is formed predominantly by the oxide or compound concerned, for example in a proportion of at least 80, 85 or 90% by mass, based on the respective material. The remaining parts by mass of the material can be formed by components which have, for example, been introduced into the product as impurities or secondary constituents via the raw materials from which the respective materials were produced. If the first material is, for example, based on MgO, MgO can, for example, have been introduced as the raw material sintered magnesia or fused magnesia into the product, so that the typical impurities or secondary constituents which are present in addition to MgO in sintered magnesia or fused magnesia can be present in addition to MgO. For example, these can be, in particular, Fe₂O₃, CaO, SiO₂ and Al₂O₃.

The second material can in principle be any material which has a coefficient of thermal expansion which is different from that of the first material and can therefore act in principle as elasticizer for the first material.

For example, the at least one second material can be one or more materials of which the first material can be formed. In this respect, the second material can, for example, be based on one or more of the following oxides or compounds: MgO, Al₂O₃, Fe₂O₃, SiO₂, CaO, Cr₂O₃, ZrO₂, Mn₂O₃, TiO₂ or one or more compounds of these oxides, for example magnesia spinel, hercynite, galaxite or forsterite.

The second material is preferably based on one or more of the following oxides or compounds: Al₂O₃, MgO, SiO₂, ZrO₂ or one or more compounds of these oxides, for example, magnesia spinel or forsterite.

The second material is particularly preferably based on Al₂O₃.

The first material and second material preferably differ from one another in respect of their composition, in particular their chemical composition, and also in respect of their physical properties.

The third material can in principle be any material which is stable during use of the product and thus forms a diffusion barrier between the first material and second material.

The third material preferably differs from the second material and/or from the first material, in particular in respect of its composition, in particular its chemical composition. Furthermore, the third material is, as indicated above, preferably selected in such a way that the invariant point both in the two-component system formed by the second material and third material and also of the two-component system formed by the first material and third material is in each case above the use temperature of the product of the invention, so that the coating formed by the third material does not form a melt phase during use of the product.

The at least one third material can be selected, in particular, taking into account the above conditions which the at least one third material should meet according to the invention. In particular, if the first material and second material are based on the abovementioned oxides or compounds, the third material can be based on at least one of the following materials: gahnite, magnesia spinel, forsterite, mullite (3 Al₂O₃.2 SiO₂), calcium zirconate (CaO.ZrO₂) or AB₂O₄ (where A=Al, Cr or Fe³⁺ and B=Mg, Zn, Fe, Mn or Ni).

If the first material is based on MgO and the second material is based on Al₂O₃, a coating composed of a third material based on gahnite has, according to the invention, been found to be particularly advantageous.

Gahnite (zinc spinel; ZnO.Al₂O₃; ZnAl₂O₄) forms on grains based on Al₂O₃ which are embedded in a matrix based on a main component in the form of MgO, a coating which, when the corresponding product is used, is stable and thus acts as diffusion barrier between MgO and Al₂O₃. As a result, the MgO cannot react with the Al₂O₃ of the flexibilizer to form magnesia spinel during use of the product. The grains based on Al₂O₃ thus remain stable in the matrix based on MgO, so that the grains based on Al₂O₃ can display their full effect as elasticizer due to their different coefficient of thermal expansion relative to MgO and the formation of undesirable mineral phase reactions between MgO and Al₂O₃ is suppressed. Furthermore, the invariant points in the multicomponent systems concerned are so high that they are generally above the temperatures prevailing during use of the product, so that a coating, for example in the form of gahnite, forsterite or mullite, does not form any melt phase during use of the product.

The at least one first material typically forms the main component of the product of the invention and can in this case be present, for example, in a proportion of at least 60% by mass, i.e. for example in a proportion of at least 65, 70, 72, 74, 75, 76, 77, 78, 79, 80, 81, 82, 83 or 84% by mass. For example, the at least one first material can also be present in the mix in a proportion of not more than 97% by mass, i.e., for example, in a proportion of not more than 96, 95, 94, 93, 92, 91, 90, 89 or 88% by mass.

The at least one second material represents the elasticizer of the product of the invention and can, for example, be present in proportions in which corresponding elasticizers are typically present in refractory ceramic products. For example, the at least one second material can be present in the mix in a proportion of at least 1, 2, 3, 4, 5, 6, 7, 8, 9 or 10% by mass. For example, the at least one second material can also be present in the mix in a proportion of not more than 30, 25, 24, 22, 20, 19, 18, 17, 16, 15, 14, 13, 12 or 11% by mass.

The proportion by mass of the at least one third material in the product can typically depend on the proportion by mass of the at least one second material in the product of the invention. Since the at least one third material is present as coating on the grains of the at least one second material, the proportion by mass of the at least one third material is higher, the higher the proportion by mass of the at least one second material in the product. For example, the proportion by mass of the at least one third material can be in the range from 8 to 75% by mass based on the proportion by mass of the at least one second material in the product, i.e., for example, also at least 12, 16, 20 and for example also not more than 50, 35 or 30% by mass based on the proportion by mass of the at least one second material in the product. For example, the proportion of the at least one third material in the product can be at least 0.4% by mass, i.e., for example, also at least 0.6% by mass, 0.8% by mass, 1.0% by mass, 1.2% by mass, 1.4% by mass, 1.6% by mass, 1.8% by mass, 2.2% by mass, 2.4% by mass, 2.5% by mass, 2.6% by mass or 2.7% by mass. Furthermore, the proportion of the at least one third material in the product can, for example, be not more than 20% by mass, i.e., for example, also not more than 15% by mass, 12% by mass, 10% by mass, 9% by mass, 8% by mass, 7% by mass, 6% by mass, 5% by mass, 4.5% by mass, 4% by mass, 3.5% by mass, 3.3% by mass, 3.2% by mass, 3.1% by mass, 3.0% by mass or 2.9% by mass.

The at least one first, second and third materials can be present on the basis of the abovementioned oxides and compounds in the product. Furthermore, the at least one first, second and third materials can be present in the form of the materials indicated in table 1 below. Table 1 shows preferred combinations of the at least one first, second and third material in each row, with the products No. 1-14 in each row each being a product comprising the first, second and third material indicated in the subsequent columns with the respective melting points and the invariant points of the respective materials systems being indicated:

TABLE 1
Instead of MgAl₂O₄ or ZnAl₂O₄, AB₂O₄ is also possible, where
A = Al³⁺, Cr³⁺, Fe³⁺ and B = Mg²⁺, Zn²⁺, Fe²⁺, Mn²⁺, Ni²⁺

| | | Invariant point | | Invariant point | |
|---|---|---|---|---|---|
| | First material | between first and | Third material | between second | Second material |
| Product | (melting point in ° C.) | third material | (melting point in ° C.) | and third material | (melting point in ° C.) |
| 1 | MgO (2820° C.) | ca. 1800° C. | ZnAl₂O₄ (1950° C.) | ca. 1720° C. | Al₂O₃ (2053° C.) |
| 2 | Al₂O₃ (2053° C.) | ca. 1720° C. | ZnAl₂O₄ (1950° C.) | ca. 1800° C. | MgO (2820° C.) |
| 3 | MgO (2820° C.) | ca. 1990° C. | MgAl₂O₄ (2135° C.) | ca. 1720° C. | 2MgO•SiO₂ (1890° C.) |
| 4 | 2MgO•SiO₂ (1890° C.) | ca. 1720° C. | MgAl₂O₄ (2135° C.) | ca. 1990° C. | MgO (2820° C.) |
| 5 | Al₂O₃ (2053° C.) | ca. 1990° C. | MgAl₂O₄ (2135° C.) | ca. 1720° C. | 2MgO•SiO₂ (1890° C.) |
| 6 | MgAl₂O₄ (2135° C.) | ca. 1720° C. | 2MgO•SiO₂ (1890° C.) | ca. 1860° C. | MgO (2820° C.) |
| 7 | MgO (2820° C.) | ca. 1860° C. | 2MgO•SiO₂ (1890° C.) | ca. 1720° C. | MgAl₂O₄ (2135° C.) |
| 8 | 2MgO•SiO₂ (1890° C.) | ca. 1720° C. | MgAl₂O₄ (2135° C.) | ca. 1990° C. | Al₂O₃ (2053° C.) |
| 9 | Al₂O₃ (2053° C.) | ca. 1840° C. | 3Al₂O₃•2SiO₂ (1860° C.) | ca. 1595° C. | SiO₂ (1723° C.) |
| 10 | SiO₂ (1723° C.) | ca. 1595° C. | 3Al₂O₃•2SiO₂ (1860° C.) | ca. 1840° C. | Al₂O₃ (2053° C.) |
| 11 | MgO (2820° C.) | ca. 1860° C. | 2MgO•SiO₂ (1890° C.) | ca. 1765° C. | ZrO₂ (2710° C.) |
| 12 | ZrO₂ (2710° C.) | ca. 1765° C. | 2MgO•SiO₂ (1890° C.) | ca. 1860° C. | MgO (2820° C.) |
| 13 | MgO (2820° C.) | ca. 2050° C. | CaO•ZrO₂ (2550° C.) | ca. 2250° C. | ZrO₂ (2710° C.) |
| 14 | ZrO₂ (2710° C.) | ca. 2250° C. | CaO•ZrO₂ (2550° C.) | ca. 2050° C. | MgO (2820° C.) |

In order to be able to serve as elasticizer for the matrix formed by the at least one first material in the product of the invention, the at least one second material has a coefficient of thermal expansion which is different from that of the at least one first material. According to the invention, the coefficient of thermal expansion of the second material can, in particular, be at least 10% greater or less than the coefficient of thermal expansion of the first material, based on the coefficient of thermal expansion of the first material. Accordingly, the coefficient of thermal expansion of the second material can, for example, also be at least 15, 20, 25, 30, 35, 40, 45 or 50% greater than or less than the coefficient of thermal expansion of the first material. The coefficient of thermal expansion of the second material is smaller than the coefficient of thermal expansion of the first material to the abovementioned extent.

The coefficient of thermal expansion is defined here as the coefficient of linear expansion α of the respective material, i.e. as the proportionality constant between the temperature change and the associated relative change in length.

The coefficient of thermal expansion α in [10⁻⁶ K] of the second material can be at least, for example, 1, 2, 3, 4 or 5 [10⁻⁶ K] greater than or less than, in particular less than, the coefficient of thermal expansion of the first material.

If the product has a plurality of first and/or second materials, what has been said above in respect of the different coefficients of thermal expansion of the first and second materials applies to at least one of the combinations of first and second material, but preferably to all combinations of first and second materials.

Preference is given to the particle size of the grains of the second material being in the medium particle size range, based on the particle size of the grains of the first material. For example, the particle size of the grains of the second material can be between the particle size of the smallest grains and the largest grains of the first material. For example, at least 10 or 20% by mass of the grains of the first material (based on the total mass of the first material) can have a smaller particle size than at least 95% by mass of the grains of the second material (based on the total mass of the second material). For example, it is also possible for at least 10 or 20% by mass of the grains of the first material (based on the total mass of the first material) to have a particle size which is greater than 95% by mass of the grains of the second material (based on the total mass of the second material).

The absolute particle size of the grains of the first and second material is in principle immaterial and can be selected according to the particle sizes known from the prior art for grains which form a matrix composed of a main component with grains of an elasticizer embedded therein. For example, 100% by mass or even at least 90% by mass of the grains of the first material (based on the total mass of the first material) can have a particle size in the range >0-10 mm or in the range >0-9 mm, >0-8 mm, >0-7 mm, >0-6 mm or >0-5 mm.

With regard to the grains of the second material, all or at least 90% by mass of these (based on the mass of the second material) can, for example, have a particle size in the range 0.5-7 mm, i.e., for example, also in the range 0.5-6 mm, 0.5-5 mm, 0.5-4 mm, 0.5-3 mm, 1-7 mm, 1-6 mm, 1-5 mm, 1-4 mm or 1-3 mm.

It has been found according to the invention that it is advantageous in terms of the effectiveness of the second material as elasticizer for the coating of the third material to have a very low thickness on the grains of the second material. At the same time, the coating of the third material on the second material should, however, be present in such a thickness that a reaction between the first material and second material can be completely or largely suppressed. In this respect, it has been found to be advantageous for the thickness of the coating of the third material on the second material to be, on average, not more than 20% of the average diameter of the grains of the second material (including the coating) and, for example, also not more than, on average, 15, 10 or 5% of the average diameter of the grains of the second material. Furthermore, the thickness of the coating of the third material on the second material can be, on average, at least 1, 2 or 3% of the average diameter of the grains of the second material (including the coating).

The average particle size diameter of the grains of the second material can, for example, be determined in accordance with DIN EN 933-1:2012.

For example, the thickness of the coating of the third material on the grains of the second material can be, on average, at least 5 μm, i.e., for example, also on average at least 10, 15, 20, 25, 30, 35, 40, 45, 50, 55, 60, 65, 70, 75, 80, 85, 90, 95 or 100 μm. Furthermore, the thickness of the coating of the third material on the grains of the second material can be, on average, not more than 1000 μm, i.e., for example, on average also not more than 900, 800, 700, 600, 500, 400 or 300 μm.

To produce the product of the invention, it is possible to make recourse to essentially the technologies known from the prior art for producing a refractory ceramic product from a main component forming a matrix with an elasticizer embedded therein. The difference between these technologies known from the prior art for producing a refractory ceramic product and the technology which is to be employed for producing a product according to the invention can be that in the case of the technology for producing a product according to the invention, a coating in the form of the at least one third material according to the invention is to be formed on the grains of the elasticizer, i.e. of the second material. According to the prior art, a mix comprising grains of the at least one first material and grains of the at least one second material can firstly be made available in order to produce a product according to the invention. The grains of the second material can have a coating which even at this stage represents the at least one third material or from which the third material is formed during the ceramic firing of the mix to give a ceramic product according to the invention.

The mix can, as is known from the prior art, comprise a green binder in order to endow an unfired body formed from the mix, known as a green body, with green strength. The green body can, optionally after prior drying, be subjected to ceramic firing so that a refractory ceramic product is formed by the ceramic firing and after subsequent cooling. The firing is, in particular, carried out at temperatures which are such that the grains of the mix sinter together and as a result form a sintered, refractory ceramic body.

If the grains of the second material are already present in the mix in such a form that they have a coating which even at this stage represents the third material, these grains can, for example, be produced in a separate process step. For this purpose, the grains of the second material can, for example, be provided with a coating on which a coating in the form of the third material is formed during firing. For this purpose, the correspondingly coated grains can, for example, be subjected to firing so that the coating of the third material is formed on the grains of the second material. The grains of the second material which have thus been coated with the third material can subsequently be introduced into the mix provided for producing the product of the invention.

As an alternative, it is possible, for example, for the grains of the second material to be provided with a coating from which the coating composed of the third material is formed, but without the grains which have been coated in this way being fired before they are introduced into the mix for producing the product of the invention. The coating in the form of the third material on the grains of the second material in this case forms only during ceramic firing of the product of the invention.

The above-described technology can, for example, be employed for coating grains of a second material based on Al₂O₃ with a third material in the form of gahnite or forsterite. The grains which have been coated in this way can be used as elasticizer for a main component in the form of grains based on MgO.

As an alternative, the grains composed of the second material can be provided with a coating from which the coating in the form of the third material is formed as reaction product from the coating and the grains composed of the second material during firing. For example, grains of a second material based on Al₂O₃ can be coated with zinc oxide (ZnO), so that a coating in the form of a third material in the form of gahnite is formed on the surface of the correspondingly coated grains during firing of these. Firing of the grains can be carried out before the coated grains are added to the mix for producing a product according to the invention. However, the coating in the form of a third material in the form of gahnite can, for example, also be formed by the grains based on Al₂O₃ coated with zinc oxide being present in unfired form in the mix and the layer of gahnite forming only during firing of the mix. Apart from grains based on Al₂O₃ coated with zinc oxide, the mix can in this case comprise, for example, grains based on MgO as main component or first material.

As an alternative, the grains of the second material can, for example, have a coating which forms a reaction product which represents the third material on reaction with the first material during ceramic firing of the product. For example, grains composed of a second material based on Al₂O₃ can have a coating based on SiO₂, with the correspondingly coated grains being present in addition to grains of a first material based on MgO as main component in a mix. During ceramic firing of a product produced from such a mix, the grains based on MgO react with the coating in the form of SiO₂ on the grains composed of the second material and thus form a coating in the form of a third material in the form of forsterite on the grains composed of the second material.

To apply the coating to the grains of the second material, a person skilled in the art can make recourse to the processes known for this purpose from the prior art, for example application via the gas phase (for example CVD or PVD), spraying-on, granulating-on or application via a solution (for example by means of a sol-gel process).

The firing temperatures for the ceramic firing of the product of the invention can be selected according to the temperatures known from the prior art for sintering a ceramic body. The corresponding temperatures are known to a person skilled in the art. For example, the firing temperatures can be in the range from 1300 to 1500° C.

A working example of the invention will be explained in more detail below.

To produce the product of the invention, a mix comprising grains of sintered magnesia (with a proportion of MgO of >90% by mass, based on the total mass of the grains of sintered magnesia) as main component in a proportion of 87% by mass, based on the total mass of the mix, is firstly made available. The grains of sintered magnesia have a particle size in the range of >0-10 mm.

Apart from grains of sintered magnesia, grains of sintered α-alumina (with a proportion of Al₂O₃ of >90% by mass, based on the total mass of the grains of sintered alumina) which are coated with zinc oxide (ZnO). The correspondingly coated grains are present in a proportion by mass of 13% by mass, based on the total mass of the mix. In the case of the coated grains, the proportion by mass of the coating of zinc oxide is 3% by mass, based on the total mass of the mix. The coated grains have a particle size in the range of 1-3 mm. The grains of sintered alumina form the grains of the second material in the product, while a coating in the form of the third material is formed from the coating on the particles of sintered alumina during ceramic firing of the product.

A green binder is added to the mix, the mix is subsequently mixed and finally pressed to give green bodies. The green bodies are subsequently dried and finally subjected to ceramic firing for about five hours, with part of the green bodies being subjected to a temperature of about 1400° C. and another part being subjected to a temperature of about 1500° C. After firing, products according to the invention are obtained.

During ceramic firing, the grains of sintered magnesia form a matrix of sintered grains based on MgO. The grains of sintered alumina form the second material in the form of grains based on Al₂O₃. Furthermore, the coating of zinc oxide reacts with the Al₂O₃ of the grains of sintered alumina and as a result a coating in the form of gahnite is formed on these grains. This coating in the form of gahnite represents a coating in the form of the third material. This coating in the form of gahnite prevents the MgO of the grains of the first material from reacting with the Al₂O₃ of the grains of the second material to form magnesia spinel. The grains based on Al₂O₃ can thus effectively act as elasticizer in the product since the Al₂O₃ of these grains does not react or reacts only in insignificant proportions with the MgO of the grains based on MgO to form magnesia spinel.

As regards the firing temperature, it has been found that the amount of gahnite formed and the thickness of the coating formed by this on the grains of sintered alumina was greater in the case of the products fired at 1500° C. than in the case of the products fired at 1300° C.

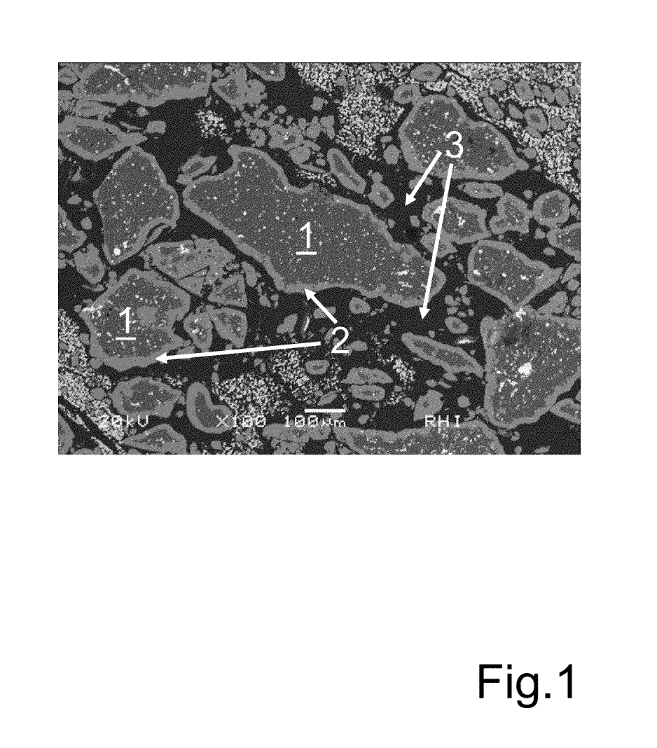

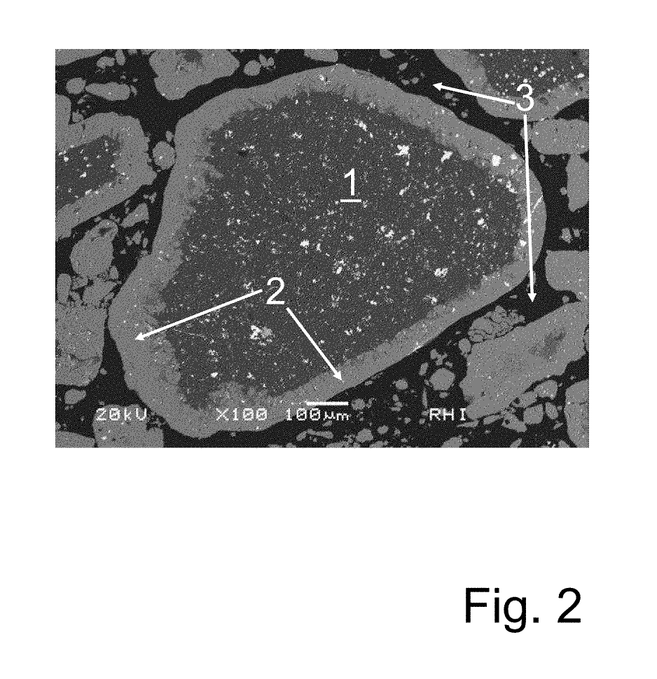

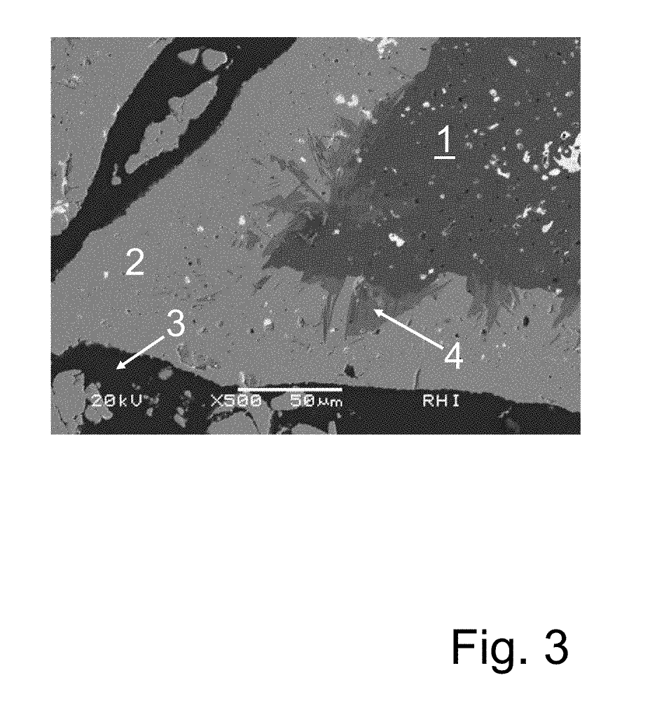

FIGS. 1 to 3 show enlarged views of polished sections of the products produced according to the above working examples. Here, FIG. 1 shows a part of a product fired at 1300° C. and FIGS. 2 and 3 show parts of a product fired at 1500° C.

FIG. 1 shows a part of about 1.27×0.95 mm. The white bar at the bottom in the middle of the image corresponds to a length of 100 μm. The matrix 3 which is formed by the first material in the form of sintered magnesia and appears black in FIG. 1 can be seen. The grains 1 of the second material in the form of alumina, which appear dark gray, are embedded in this matrix 3. The coating 2 in the form of the third material composed of gahnite which is present on the surface of the grains 1 appears as light-gray seam surrounding the grains 1 in FIG. 1. The coating 2 has a thickness in the range from about 10 to 30 μm; the average thickness of the coating 2 is about 20 μm.

FIG. 2 depicts a part of the product on the same scale as FIG. 1. Once again, the matrix of sintered magnesia is denoted by the reference numeral 3. The coating 2 composed of gahnite can be seen particularly well on the large grain 1 composed of alumina embedded in the matrix 3. Owing to the higher firing temperatures, the coating 2 composed of gahnite has a greater thickness, namely in the range from about 50 to 150 μm; the average thickness of the coating 2 is about 100 μm.

FIG. 3 shows a more highly magnified part of the product as per FIG. 2. The part depicted has a size of about 270×200 μm. A section of the peripheral region of an alumina grain 1 with the coating 2 of gahnite can be seen. On the side of the coating 2 facing the magnesia matrix 3, the coating 2 comprises not only gahnite but also regions containing proportions of magnesia, and on its side facing the alumina grain 1 the coating 2 has regions containing proportions of alumina. The mass ratio of ZnO to Al₂O₃ in the interior of the coating 2 is thus about 44.4:55.6 and therefore corresponds approximately to the stoichiometric ratio of these oxides in gahnite. In contrast, for example, the mass ratio of ZnO to Al₂O₃ in the region 4 of the coating 2 is about 21:79.

1. A refractory ceramic product whose microstructure has the following features:
a matrix composed of at least one first material;
grains of at least one second material are embedded in the matrix;
the grains of the second material have a coating composed of at least one third material on at least part of their surface;
the first and second material have a different coefficient of thermal expansion;
the third material is stable during use of the product.

2. The product as claimed in claim 1 in the form of a sintered product.

3. The product as claimed in claim 1, wherein the first material is based on one or more of the following oxides or compounds: MgO, Al₂O₃, Fe₂O₃, SiO₂, CaO, Cr₂O₃, ZrO₂, Mn₂O₃, TiO₂ or one or more of the compounds magnesia spinel, hercynite, galaxite or forsterite.

4. The product as claimed in claim 1, wherein the second material is based on one or more of the following oxides or compounds thereof: Al₂O₃, MgO, SiO₂ or ZrO₂.

5. The product as claimed in claim 1, wherein the third material is based on at least one of the following materials: gahnite, magnesia spinel, forsterite, mullite, calcium zirconate or AB₂O₄ (where A=Al³⁺, Cr³⁺ or Fe³⁺ and B=Mg²⁺, Zn²⁺, Fe²⁺, Mn²⁺ or Ni²⁺).

6. The product as claimed in claim 1, wherein the thickness of the coating is in the range from 5 to 300 μm.

7. The product as claimed in claim 1, wherein the first material is in the form of grains sintered to one another.

8. The product as claimed in claim 1, wherein the coefficient of thermal expansion of the second material is at least 10% greater or less than the coefficient of thermal expansion of the first material, based on the coefficient of thermal expansion of the first material.

9. The product as claimed in claim 1, wherein the particle size of the grains of the second material is between the particle size of the smallest grains and the largest grains of the first material.
